(19) United States
(12) Patent Application Publication
(10) Pub. No.: US 2025/0181844 A1
(43) Pub. Date: Jun. 5, 2025

(54) AXIOMATIC PREFERENCE MODELS TO SCORE RESPONSES TO PROMPTS

(71) Applicant: MICROSOFT TECHNOLOGY LICENSING, LLC, Redmond, WA (US)

(72) Inventors: Corbin ROSSET, Redmond, WA (US); Paul Nathan BENNETT, Redmond, WA (US); Guoqing ZHENG, Redmond, WA (US); Ahmed AWADALLAH, Redmond, WA (US)

(21) Appl. No.: 18/525,781

(22) Filed: Nov. 30, 2023

(51) Int. Cl. G06F 40/40; G09B 7/04

(52) U.S. Cl. CPC G06F 40/40; G09B 7/04

(57) ABSTRACT

Disclosed is a preference model that improves the alignment of large language model (LLM) responses. For a particular scenario, a set of principles are identified that, when adhered to by the LLM, improve the quality of LLM responses. In a long form question and answer scenario, better answers tend to be useful, relevant, grounded, thorough, and true, although more and different principles are similarly contemplated. In a scenario that generates a movie script, better responses may include a relatable protagonist, a character arc, and a satisfying denouement. The disclosed axiomatic preference model is trained to understand when a response does or does not adhere to these principles. Once trained, the preference model may be used as a drop-in replacement of existing preference models used to train an LLM.

### BACKGROUND

Recent advances in large language models (LLMs) have seen the introduction of diverse post-training strategies including Reinforcement Learning from Human Feedback (RLHF) and Reinforcement Learning from AI Feedback (RLAIF). These techniques have helped bridge the “alignment gap” between the responses of raw pretrained language models and responses that resonate more closely with human preferences. These techniques steer LLMs to prefer one response over another based-on feedback from human annotators or another LLM.

RLHF uses a “reward model” (RM)—a machine learning model trained to encode human preferences. When training an LLM, the RM grades the output of the LLM, generating a scalar score for LLM-generated responses. The scalar score is used during back-propagation to train the LLM.

While RMs have proved useful for training LLMs, training and operating the RM is itself a significant investment of time, energy, and computing power. Existing RM training techniques produce training data that aligns poorly with human preferences. Longer training runs and larger model sizes are used to compensate. Longer training runs result in increased costs to train the RM, while larger model sizes result in increased costs to train the LLM.

It is with respect to these and other considerations that the disclosure made herein is presented.

### SUMMARY

Disclosed is a preference model that improves the alignment of large language model (LLM) responses. For a particular scenario, a set of principles are identified that, when adhered to by the LLM, improve the quality of LLM responses. In a long form question and answer scenario, better answers tend to be useful, relevant, grounded, thorough, and true, although more and different principles are similarly contemplated. In a scenario that generates a movie script, better responses may include a relatable protagonist, a character arc, and a satisfying denouement. The disclosed axiomatic preference model is trained to understand when a response does or does not adhere to these principles. Once trained, the preference model may be used as a drop-in replacement of existing preference models used to train an LLM.

For each principle, axiomatic preference model training data is generated that highlights that principle. In some configurations, a pair of responses is generated for a given prompt: a positive response that adheres to the principle and a negative response that does not adhere to the principle. The axiomatic preference model is trained with these pairs of responses, enabling it to learn the difference between responses that adhere to the principle and responses that do not.

The positive response and the negative response are constructed to be similar in aspects other than the principle, isolating positive and negative expressions of the principle. For example, positive and negative responses may be generated to highlight the principle of relevance. The positive response may be constructed as a correct response to the prompt, while the negative response is constructed as a correct response to a related prompt. Quality, truthfulness, and other aspects of both responses are the same, allowing for the difference in the relevance to be appreciated by the preference model.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates training an axiomatic preference model using positive and negative preference pairs.

FIG. 2 illustrates constructing positive and negative responses according to a usefulness principle.

FIG. 3A illustrates constructing a positive response according to a relevance principle.

FIG. 3B illustrates constructing a negative response according to a relevance principle.

FIG. 4 illustrates constructing positive and negative responses according to a groundedness principle.

FIG. 5 illustrates constructing positive and negative responses according to a truthfulness principle.

FIG. 6 illustrates constructing positive and negative responses according to a thoroughness principle.

FIG. 7 is a flow diagram of an example method for axiomatic preference models to score answers to long-form prompts.

FIG. 8 is a computer architecture diagram illustrating an illustrative computer hardware and software architecture for a computing system capable of implementing aspects of the techniques and technologies presented herein.

### DETAILED DESCRIPTION

Existing techniques for training reward models regress a single scalar preference score, typically annotated by humans. However, the reward model (RM) does not have clear knowledge of why the humans made their decisions or what principles they operated under. This lack of context results in an RM that is less accurate and requires more training and larger numbers of parameters to obtain a specific level of accuracy.

Another deficiency in existing RM training techniques is that underlying preference pairs do not come from diverse sources, often being sampled from the same LLM the RM is used to train. It is also not clear that RMs can reliably score human-written and LLM-generated responses on the same scale, which is more challenging than previously anticipated due to vast differences such as style. Without clear signals of which principle informs the preference decision, and diverse sources of training examples upholding it, a RM may not be aligned with the expectations of human stakeholders.

For instance, studies have shown that RLHF finetuned LLMs may fall short of key expectations—e.g. by failing to support claims with evidence, or making claims that sound convincing but are untrue. Deficiencies in existing reward models can also be seen by comparing top-voted answers from question-and-answer forums to answers generated by state-of-the-art models. It has been observed that the top-voted answer taken from a question-and-answer forum typically receives a higher score than answers produced by models. This has been found to be true even though model-generated answers appear at first glance to be high quality. This deficiency in the answers generated by machine learning models can be attributed in part to a failure of the reward model used to train it. As referred to herein, a reward model is a preference model applied to the task of RLHF, and the terms are used interchangeably.

To address these issues, principles are identified that humans desire out of an LLM. Different principles may be applied to different LLM scenarios. In the case of a long-form question answering scenario, non-limiting principles that improve quality may include usefulness, relevance, groundedness, truthfulness, and thoroughness. Some of these principles target known failure modes of modern LLMs, such as hallucinating incorrect statements that appear factual or being distracted by irrelevant context. Other principles enforce capabilities, such as incorporating evidence, or addressing multiple perspectives.

In some configurations, for a given prompt, candidate response pairs are constructed “axiomatically” for one or more of the scenario-specific principles. For a particular principle, one response—the “positive” response—is clearly preferred according to that principle. The other response—the “negative” response—clearly is less preferred according to the principle. Generating a preference pair that distinguishes the positive and negative responses according to the principle provides a richer, more targeted preference pair than existing techniques. Preference pairs may be constructed with weak human preferences in the form of “upvotes” from Community-based Question Answering (CQA) sites like STACKEXCHANGE and REDDIT.

A reward model RMtakes as input a question q, an answer a, and outputs a scalar RM(q, a)∈ [symbol] “preference score”. RM has an optional input reserved for evidence passages e denoted RM(q, e, a). RM may be a transformer-based cross-encoder f whose input is a linearized sequence of tokens x constructed from the concatenation of q and a; denoted x=q⊙a. The output scalar is obtained from a linear regressor layer on the final transformer layer's classification token. As described herein, contrastive pairs of sequences are constructed, such that the positive response in one sequence x⁺=q⊙a⁺ is preferred over a negative response to the same prompt x⁻=q⊙a⁻. At training time, the sequences are fed into f separately. The RM receives a positive reward when preference score of the positive example is higher: f(x⁺)>f(x⁺). In some configurations, a margin loss function generates the reward, but other types of loss functions are similarly contemplated:

$$L = max ( 0 , λ - ( f ( {x}^{+} ) - f ( {x}^{-} ) ) \qquad ( 1 )$$

where the margin, μ, between the positive and negative sequence in a pair can be fixed or computed. In some configurations, axioms may be defined mathematically by more than one inequality, which translates into an equal number of loss functions that are applied when training the preference model.

The construction of positive and negative answers may be defined mathematically for each axiom. Furthermore, inequalities may be defined that establish which answer, positive or negative, should receive a higher score from the preference model. These inequalities may be used to construct training data. Table 1 illustrates pair construction for a number of principles discussed herein:

| PRINCIPLE | DESCRIPTION | PAIR CONSTRUCTION |
|---|---|---|
| 0. Usefulness | Upvotes from CQA forums | If A′ > upvotes than A″ |
| | | PM(Q, A′) > PM(Q, A″) |
| 1. Relevance | Answer, A, to Q should be more | A: =Any Answer to Q |
| | relevant than answer B to | B: =Answer to Q′ |
| | related question Q′, | PM(Q, A) > PM(Q, B) |
| | Q′ ∈ knn(Q) | |
| 2. Grounded-ness | LLM Answer with context of | C: =LLM(Q) “closed book” |
| | relevant passages P⁺ is | D: =LLM(P+, Q) “open book” |
| | better than without | PM(Q, D) > PM(Q, C) |
| 3. Truthfulness | LLM corrupts relevant answer D | E: =LLM-Corrupt(D, Q) |
| | yielding | PM(Q, C) > PM(Q, E) |
| | “wrong-but-believable answer” | PM(Q, D) > PM(Q, E) |
| 4. Relevant vs. | LLM with w/ relevant context P⁺ | F: =LLM(P−, Q) |
| Irrelevant | is better than one w/irrelevant | PM(Q, D) > PM(Q, F) |
| Grounding | context P⁻ | |
| 5. Thoroughness | Use an LLM to combine the top | G: =LLM-Combine(Q, A′, A″) |
| | two user-upvoted answers, | PM(Q, G) > PM(Q, A) |
| | A′ and A″ | A ∉ {A′, A″} |

Reward models trained as described herein may be utilized when applying reinforcement learning with human feedback (RLHF) to train a machine learning model. At a high level, a machine learning model should output a response that was given a high score by a reward model. Metaphorically, the language model is a student and the reward model is a teacher that provides feedback as to whether the language model is doing a good job or not. Continuing the metaphor, one key to effective RLHF is to have a competent teacher that can accurately discern between good and bad outputs. Training a preference model with axioms, as discussed herein, increases the effectiveness of RLHF training. The resulting RM may be integrated into any language model training pipeline, improving the accuracy and usefulness of the language models it is used to train.

The axiomatic reward model trained using the techniques described herein has been experimentally evaluated to produce superior results to other reward models. The MS Marco benchmark has thousands of questions, each of which has a fixed number of candidate answers. For each question there may be one correct answer and a thousand or more incorrect answers. It is very challenging to select the correct answer out of a thousand possibilities. Reward models trained using the techniques described herein have been shown to outperform GPT-4 on these metrics, in addition to performing three times better than open source LLMs with a similar number of parameters.

Researchers agree that a reward model should penalize untruthful or wrong answers. But existing reward models are not trained with real life examples of how answers can be wrong. The reward model needs to know various ways that answers can be wrong. They can be off in terms of the percentages that are included in the answer. They say wrong things, they can hallucinate. If a reward model doesn't have a good idea of the real in-the-wild examples of how language models get tripped up, then the reward model doesn't know how to discern good and bad answers along these dimensions.

The training data generated by the disclosed embodiments provide real life examples of how existing LLMs get things wrong. At the same time, it provides examples of how to correct for what the LLM has gotten wrong, because the positive answer is more or less a correction of the negative answer. The disclosed reward model performs as well as it does because it is familiar with how things look when an answer is wrong and how things look when an answer is right, enabling it to find a needle in the haystack. As such the disclosed axiomatic reward model may be used as a drop-in replacement or addition to existing reward models used in an RLHF based process for training LLMs.

The axiomatic reward model is a feed-forward network with a regressor layer that outputs a single value. The single values ranks an answer that has been provided as input to the model.

Many times the answers of a positive-negative pair are textually very similar to each other. For example, a positive-negative pair generated by a groundedness axiom may contain a positive answer that is open book—it cites to external sources, and in a proper way. The corresponding negative answer may be closed book, not providing any references. However, the content of the answers may be similar—both the overall concept and even specific language—in spite of these differences. By supplying answers that differ in this way as part of the same training batch, the reward model is able to compare them, and is therefore able to more efficiently learn to identify the principle that is accentuated by the example. The model is forced to deal with subtle textual differences that may in fact be substantial differences in quality. The model is able to make subtle distinctions in this way because the positive answer and the negative answer are provided as a pair, not as individually scored answers. Existing reward models do not considers these subtleties, and so their training data does not have this level of granularity, which is why they perform poorly.

In some configurations, the lambda value of the loss function 180 is computed per-pair. For example, an LLM may be asked to quantify how far apart the positive 126 and negative 128 responses are. Computing different lambdas for different pairs based on this difference is in contrast to typical loss functions, which compute a single lambda value and apply it to all inputs.

In some configurations, lamba is set higher to increase the punishment for a wrong response when the prompt is easy. If the model makes a mistake for an easy prompt, the punishment is severe. Per-pair lamba is a refinement of the training regimen, in that the model knows which answer is better, and by how much, on a per-pair basis. Previously it only knew which answer was better.

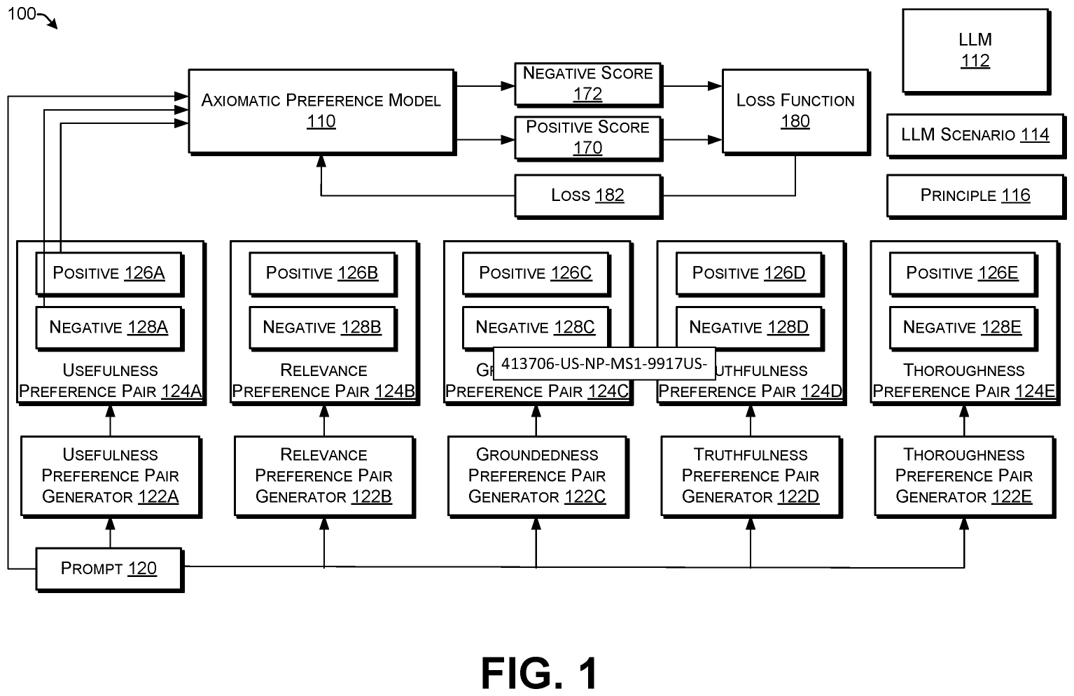

FIG. 1 illustrates training axiomatic preference model 110 using preference pairs 124. Axiomatic preference model 110 is a regressor—a model that aims to predict continuous output values based on input features. Specifically, it takes text as input, such as a combination or concatenation of prompt 120 and positive response 126A, and outputs a numerical score such as positive score 170. When training axiomatic preference model 110 using preference pairs 124, at least one positive score 170 and one negative score 172 are generated and used to invoke loss function 180. Loss function 180 emits loss 182, which is used to train axiomatic preference model 110.

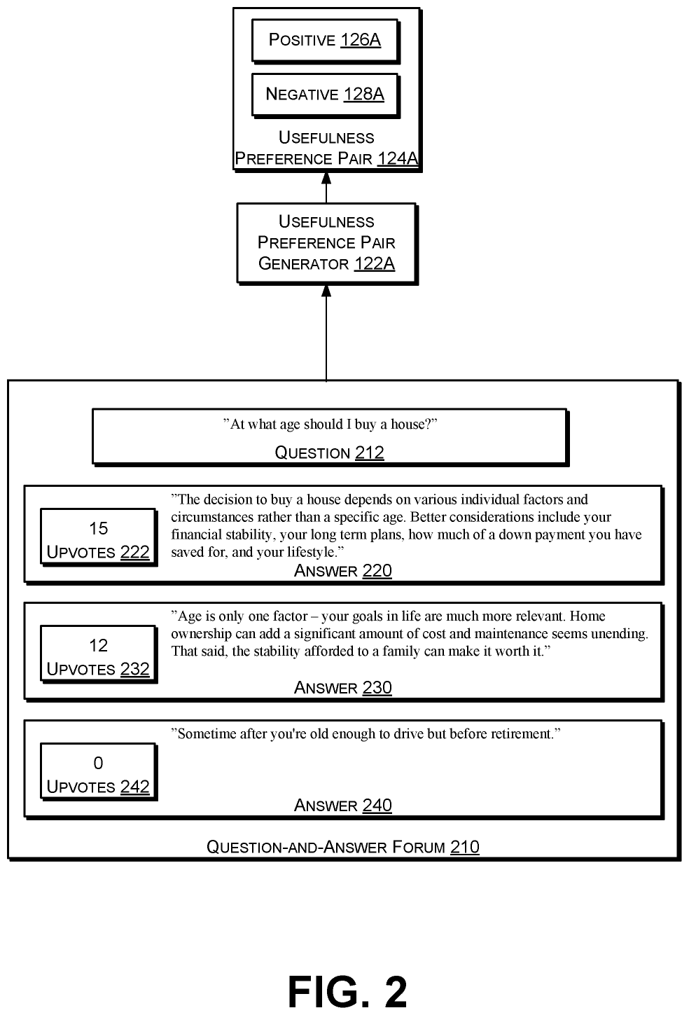

FIG. 1 illustrates a number of preference pair generators 122 that construct positive-negative pairs of responses—preference pairs 124—for a given prompt 120. Specifically, prompt 120 may be provided to usefulness preference pair generator 122A, relevance preference pair generator 122B, groundedness preference pair generator 122C, truthfulness preference pair generator 122D, and thoroughness preference pair generator 122E, although different subsets of preference pair generators 122 as well as additional preference pair generators are similarly contemplated. Each preference pair 124 generated by one of the preference pair generators includes positive response 126 and negative response 128. The details of how each of these responses are generated is described below in conjunction with FIGS. 2-6. Briefly, each preference pair generator 122 is associated with an eponymous principle 116. Positive response 126 is a response to prompt 120 that satisfies the corresponding ‘relevance’ principle. Similarly, negative response 128 is a response to prompt 120 that does not adhere to the ‘relevance’ principle.

FIG. 2 illustrates how usefulness preference pair generator 122A constructs positive response 126A and negative response 128A of usefulness preference pair 124A. Positive response 126A and negative response 128A are, along with prompt 120, training data used to train axiomatic preference model 110. In order to obtain useful and non-useful responses, usefulness preference pair generator 122A finds a question 212 on community question and answer (CQA) forum 210 that serves as prompt 120. Usefulness preference pair generator 122A uses answers from CQA forum 210 to construct positive response 126A and negative response 128A.

For example, usefulness preference pair generator 122A may obtain a highly upvoted answer, such as a top vote getter or an answer within a defined percentage of top vote getters, as the basis for positive response 126A. As illustrated, answer 220 has 15 upvotes 222, which is more than answer 230 with 12 upvotes 232 and significantly more than answer 240, which does not have any upvotes 242. In this example, answer 220 may be selected as the basis for positive response 126A and answer 240 may be selected as the basis for negative response 128A.

CQA forums such as REDDIT and STACK EXCHANGE are useful because questions can receive multiple answers among which users can specify their preferences via “upvote” or “downvote” signals. Typically, answers that have more upvotes are more useful, of higher quality, more thorough, and otherwise superior to those with fewer upvotes. As such, a preference model ought to give a higher score to answers with more upvotes. Answers from a CQA forum may also be ranked in part by downvoting, starring, or the like.

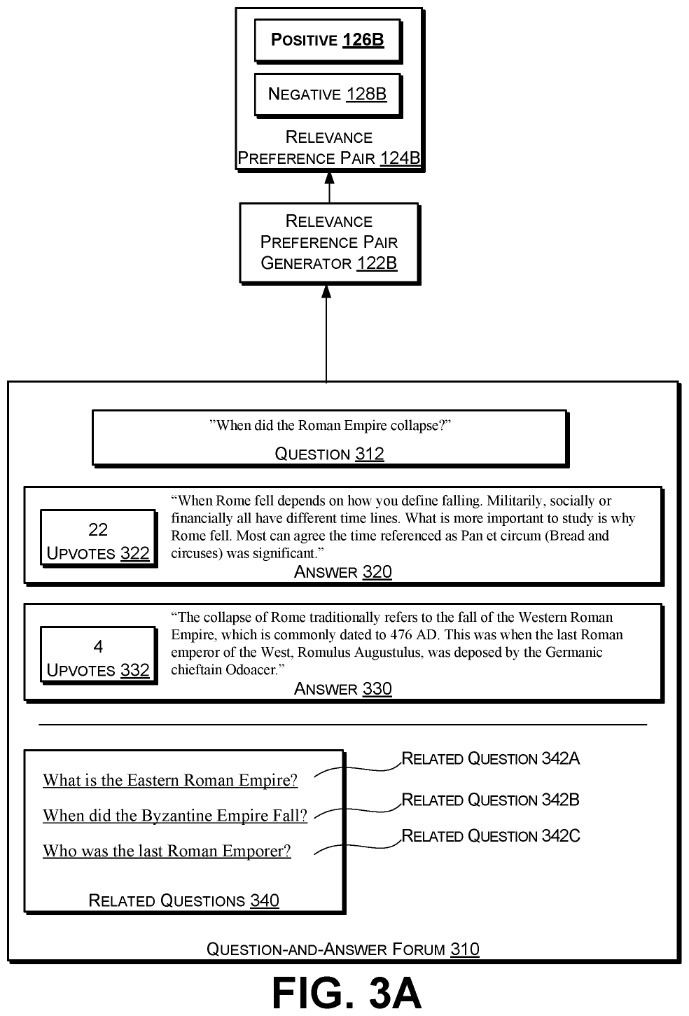

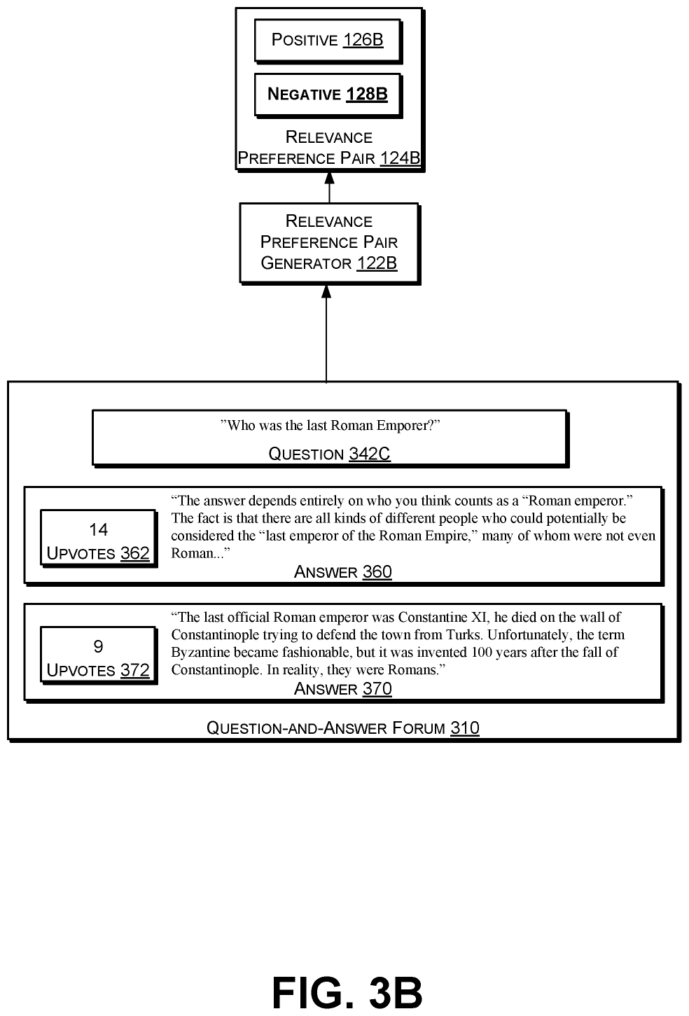

FIG. 3A illustrates constructing a positive response 126B according to a relevance principle. Relevance preference pair generator 122B constructs positive response 126B and negative response 128B as responses that do and do not adhere to the relevance principle.

Relevance is desirable principle in an answer. A relevant answer is an answer that responds to the question that was posed. A non-relevant answer is an answer to a different question. The different question may be related, or even superficially similar to the actual question, but is in fact a different question. As such, a relevance axiom may generate a positive answer by obtaining a highly up-voted answer to a question posted to a CQA forum. A negative answer may be generated by selecting an answer to a related question. In some configurations, the related question may be obtained from a list of “related questions” that is displayed on the same page as the particular question, although other techniques for finding a related question are similarly contemplated such as consulting a search engine.

As illustrated, a highly upvoted answer is obtained from CQA forum 310. Question 312, which is derived from or is the basis for prompt 120, may have a number of answers. Answer 320 has 22 upvotes 322, while answer 330 only has 4 upvotes 332. Often the answer with the most votes will be selected as the basis for positive response 126B, although in other embodiments the answer used to construct positive response 126B may be selected from a top number or top percentage of answers, as measured by upvotes or other confidence measures.

CQA forum 310, as is common, displays a list 340 of related questions 342. Relevance preference pair generator 122B may select from related questions list 340 to open a related question. Relevance preference pair generator 122B may then obtain an answer to the related question. See FIG. 3B and corresponding discussion below.

FIG. 3B illustrates constructing a negative response 128B according to the relevance principle. As discussed above in conjunction with FIG. 3A, CQA forum 310 may be opened to question 342C, which is one of the questions listed as related to question 312. One of the top-rated answers to question 342C may be selected as the basis for negative response 128B, such as answer 360 which has 14 upvotes. In this example, answer 370, with 9 upvotes 372, is not selected for inclusion in relevance preference pair 124B. Answer 360 may adhere to the other principles as much or more than answer 320. However, since answer 360 does not answer the question 120, constructing relevance preference pair 124B as described above presents axiomatic preference model 110 with an example of responses with contrasting amounts of relevance.

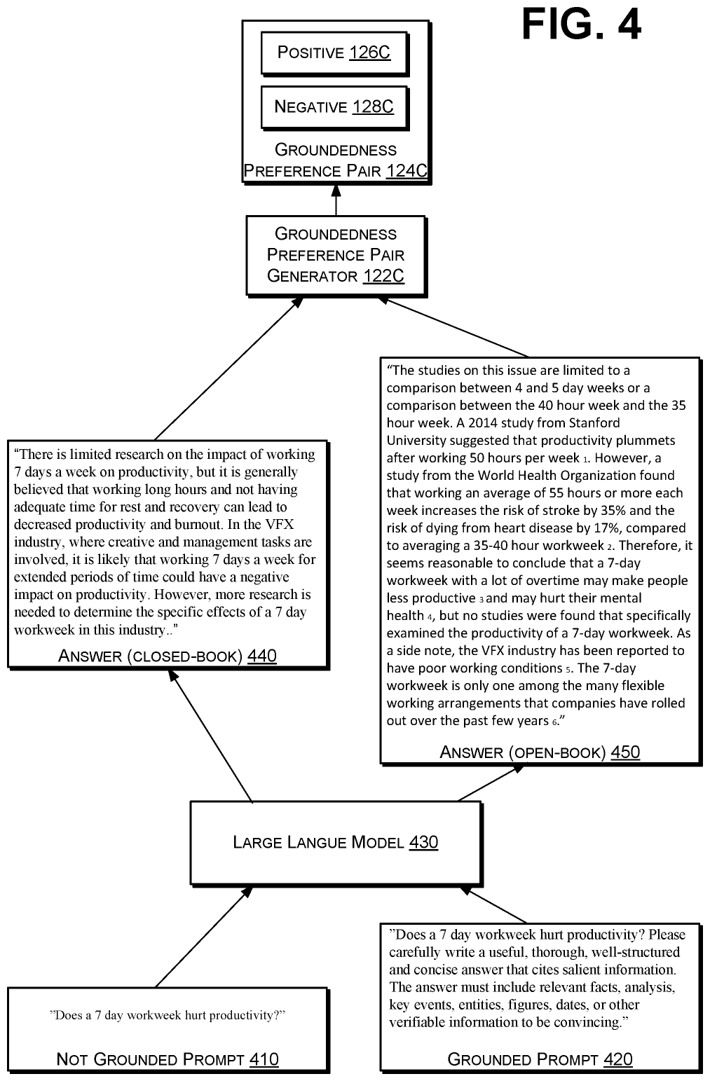

FIG. 4 illustrates constructing positive and negative responses according to a groundedness principle. Groundedness is a desirable principle in an answer. A well-grounded answer is an answer that cites sources correctly. A poorly grounded answer is an answer that does not cite to external sources, or does not do so correctly. As such, a groundedness preference pair generator 122C may generate positive response 126C by using an LLM to generate an open book answer 450. An open book answer refers to an answer that cites to external sources. Additionally, or alternatively, groundedness preference pair generator 122C may obtain open-book answer 450 from a question-and-answer forum that contains links, citations, and other ways of referencing an external authority.

In some configurations, generator 122C may construct closed-book answer 440 using LLM 430. As referred to herein, a closed-book answer is an answer that does not cite to external sources.

Grounded prompt 420 may be generated by LLM 430 using a template that can be used to direct language model 430 to generate open-book answer 450. One example prompt template is as follows:
### Consider the evidence offered in the following Passages:
### Evidence: $EvidencePassages
### Question: $Question
### Instructions: Please carefully write a useful, thorough, well-structured and concise answer to the Question: “$Question” that cites salient information stated in the Evidence Passages. The answer must include relevant facts, analysis, key events, entities, figures, dates, or other verifiable information to be convincing. Use the Passages to ground your answer, but avoid those that are irrelevant to the question or do not support key points in your answer. If you choose to use them, please cite Passages in parentheses e.g. “(Passage 4)” or “(Passage 4, 5)”; do not use dashes. When you are done, please conclude your response with “=====”
### Grounded Answer:—

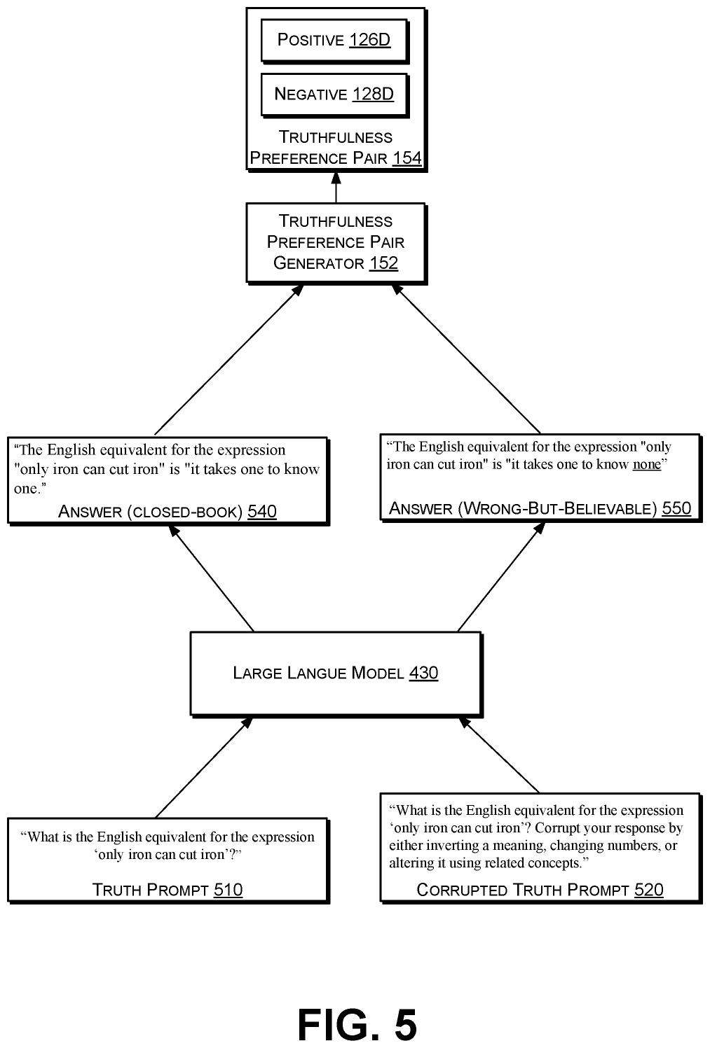

FIG. 5 illustrates constructing positive and negative responses according to a truthfulness principle. Truthfulness is another desirable principle in an answer. A truthful answer is an answer that is consistent with consensus knowledge. An untruthful answer is errant or even intentionally misleading.

Truthfulness preference pair generator 122D may generate a positive response 126D by obtaining a highly up-voted answer from a CQA forum. Highly up-voted answers obtained from a CQA forum are assumed to be truthful. Additionally, or alternatively, a positive response may be generated by a large language model. As illustrated, truth prompt 510, which reflects prompt 120, is processed by natural language model 430 to generate closed-book answer 540. Closed-book answer 540 is assumed to be a truthful answer.

In some configurations, negative answer 128D may be generated by prompting machine learning model 430 to generate an answer that is convincing but wrong. As illustrated, corrupted truth prompt 520, which may be generated from a template, causes language model 430 to generated answer 550, which is believable but wrong. An example of a template used to generate answer 550 listed below asks large language model 430 to isolate particular pieces of information and replace them with a false piece of information.
### Question: $Question
### Evidence: $EvidencePassages
### Answer: $Answer
### Instructions: 1) List the factual and verifiable claims in the above Answer between <Claim> and </Claim> tags. If there are none, output a blank string: <Claim></Claim>. Then 2) Corrupt some of the above Claims in a believable way by either inverting their meaning, changing numbers in them, or altering them using related concepts. List the new corrupted facts between <CorruptedClaim> and </CorruptedClaim> tags. Then 3) rewrite the Answer between <CorruptedAnswer> and </CorruptedAnswer> tags to have both obvious and subtle flaws using the corrupted facts. When you are finished, please conclude your response with “=====”.

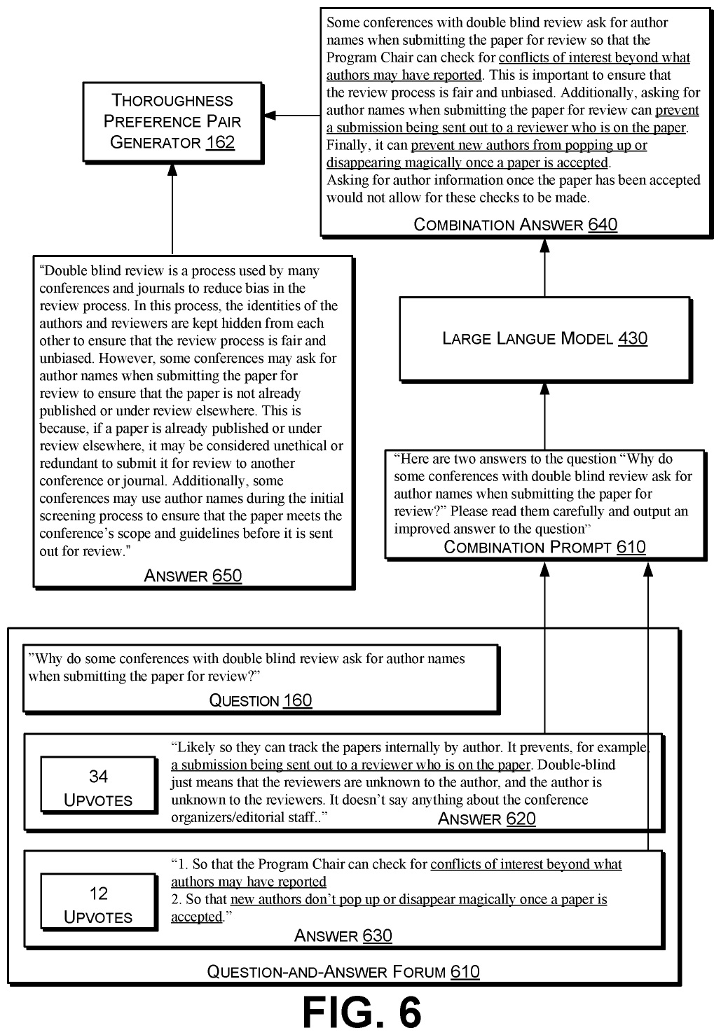

FIG. 6 illustrates constructing positive and negative responses according to a thoroughness principle. Thoroughness is another desirable principle in an answer. A thorough answer is an answer that is comprehensive and has sufficient detail. An unthorough answer may be a high level, surface only answer. In some configurations, a positive answer generated by a thoroughness axiom may be a synthesis of two or more highly up-voted answers obtained from a CQA forum. A negative answer may be obtained by asking a machine learning model to strip out details of a thorough answer, or by generating an unthorough answer to the question itself.

Thoroughness preference pair generator 162 obtains combination answer 640 by prompting large language model 430 to combine two answers. In some configurations, answer 620 and answer 630 are obtained from CQA forum 610. Answers 620 and 630 may be highly voted answers to question 160, which is the same as or derived from question 120. Additionally, or alternatively, answers 620 and/or 630 may be obtained from a large language model, search engine, or other source.

Answers 620 and 630 may be combined using combination prompt 610. Combination prompt 610 instructs LLM 430 to answer question 120 using the information contained in answers 620 and 630. An example prompt for combining answers is listed below:
### Below you are given a Question and two candidate answers, Answer A and Answer
### Question: $Question
### Answer A: $AnswerA
### Answer B: $AnswerB
### Instructions: Above are two answers to the question: “$Question”. Please read them carefully and output an improved answer to the question; you may choose to incorporate elements from both or either Answer A and Answer B into the new answer as appropriate, or include additional information not present in the answers if it provides value-add. When you are finished, conclude your revised answer with “=====”
Improved Answer:

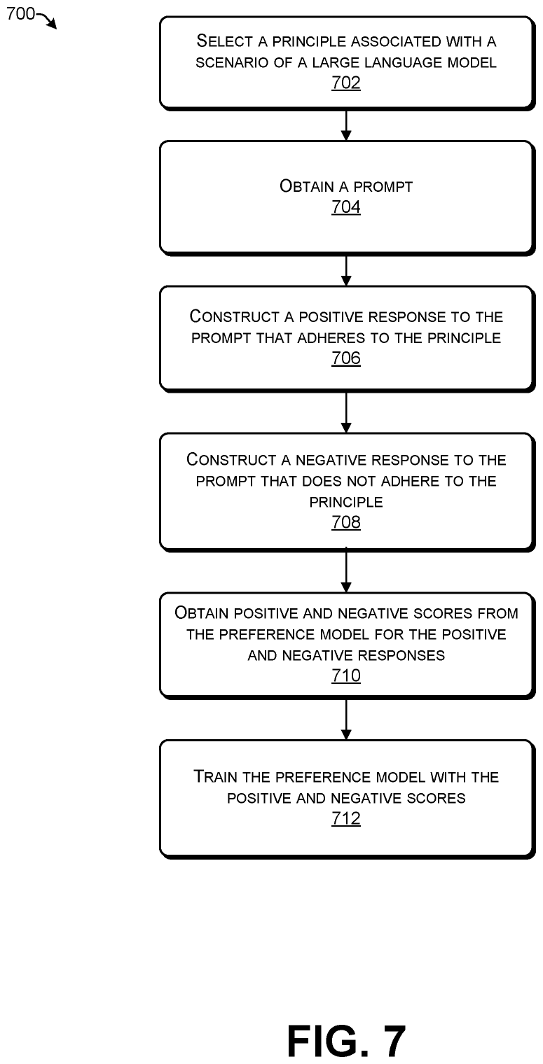

FIG. 7 is a flow diagram of an example method for axiomatic preference models to score responses to prompts. Routine 700 begins at operation 702, principle 116 is selected for scenario 114 of large language model 112. Large langue model 112 is one example of a machine learning model architecture that is used as an example throughout this document. Other machine learning architectures, such as a diffusion architecture, are similarly contemplated.

Next at operation 704, a prompt used to train the preference model is obtained. In some configurations, prompt 120 is obtained from a community question and answer (CQA) forum.

Next at operation 706, positive response 126 is constructed from an axiom defined by the selected principle 116. Examples of positive responses are listed above in table 1, and examples of constructing positive responses from CQA forums, LLMs, and other sources can be found in the descriptions of FIGS. 2-6.

Next at operation 708, negative response 128 is constructed from the same axiom as was used in the construction of positive response 126 as described above.

Next, at operation 710, positive score 170 and negative score 172 are inferred from axiomatic preference model 110.

Next, at operation 712, axiomatic preference model 110 is trained based on positive score 170 and negative score 172. For example, positive score 170 and negative score 172 may be passed to loss function 180, which produces loss 182, which be used when training axiomatic preference model 110.

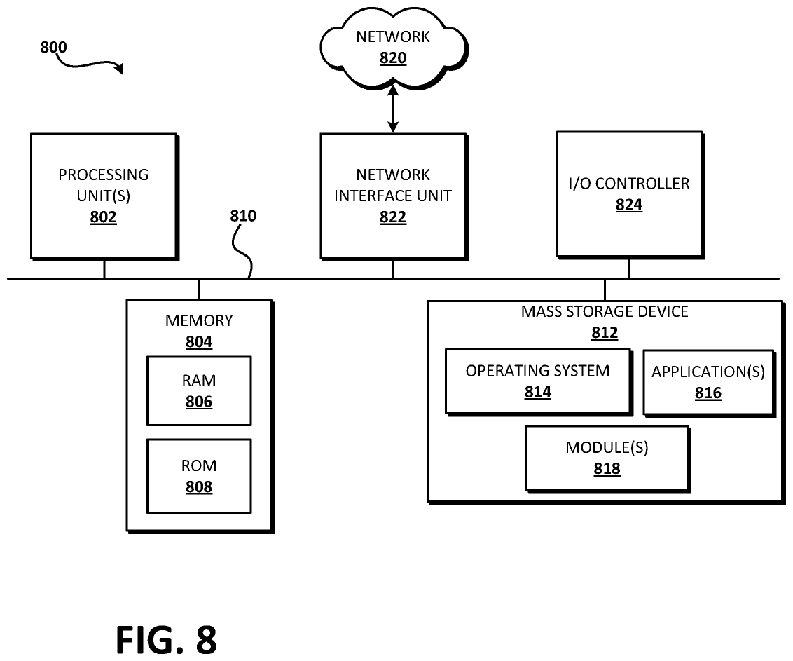

FIG. 8 shows additional details of an example computer architecture 800 for a device, such as a computer or a server configured as part of the systems described herein, capable of executing computer instructions (e.g., a module or a program component described herein). The computer architecture 800 illustrated in FIG. 8 includes processing unit(s) 802, a system memory 804, including a random-access memory 806 (“RAM”) and a read-only memory (“ROM”) 808, and a system bus 810 that couples the memory 804 to the processing unit(s) 802. The processing unit(s) 802 include one or more hardware processors and may also comprise or be part of a processing system. In various examples, the processing unit(s) 802 of the processing system are distributed. Stated another way, one processing unit 802 may be located in a first location (e.g., a rack within a datacenter) while another processing unit 802 of the processing system is located in a second location separate from the first location.

Processing unit(s), such as processing unit(s) 802, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 800, such as during startup, is stored in the ROM 808. The computer architecture 800 further includes a mass storage device 812 for storing an operating system 814, application(s) 816, modules 818, and other data described herein.

The mass storage device 812 is connected to processing unit(s) 802 through a mass storage controller connected to the bus 810. The mass storage device 812 and its associated computer-readable media provide non-volatile storage for the computer architecture 800. Although the description of computer-readable media contained herein refers to a mass storage device, it should be appreciated by those tooled in the art that computer-readable media can be any available computer-readable storage media or communication media that can be accessed by the computer architecture 800.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 800 may operate in a networked environment using logical connections to remote computers through the network 820. The computer architecture 800 may connect to the network 820 through a network interface unit 822 connected to the bus 810. The computer architecture 800 also may include an input/output controller 824 for receiving and processing input from a number of other devices, including a keyboard, mouse, touch, or electronic stylus or pen. Similarly, the input/output controller 824 may provide output to a display screen, a printer, or other type of output device.

It should be appreciated that the software components described herein may, when loaded into the processing unit(s) 802 and executed, transform the processing unit(s) 802 and the overall computer architecture 800 from a general-purpose computing system into a special-purpose computing system customized to facilitate the functionality presented herein. The processing unit(s) 802 may be constructed from any number of transistors or other discrete circuit elements, which may individually or collectively assume any number of states. More specifically, the processing unit(s) 802 may operate as a finite-state machine, in response to executable instructions contained within the software modules disclosed herein. These computer-executable instructions may transform the processing unit(s) 802 by specifying how the processing unit(s) 802 transition between states, thereby transforming the transistors or other discrete hardware elements constituting the processing unit(s) 802.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

### ILLUSTRATIVE EMBODIMENTS

The following clauses describe multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Example 1: A method comprising: selecting a principle associated with a scenario of a large language model; obtaining a prompt; constructing a positive response to the prompt that adheres to the principle; constructing a negative response to the prompt that does not adhere to the principle; obtaining a positive score from a preference model for the positive response; obtaining a negative score from the preference model for the negative response; and training the preference model with the positive score and the negative score.

Example 2: The method of Example 1, wherein the principle is selected from a plurality of principles associated with the scenario.

Example 3: The method of Example 1, wherein the positive response and the negative response are constructed to highlight adherence to the principle.

Example 4: The method of Example 3, wherein the positive response and the negative response highlight adherence to the principle by being constructed to be substantially similar in aspects other than the principle.

Example 5: The method of Example 1, wherein the scenario comprises long-form question and answer, wherein the prompt comprises a question, wherein the positive response comprises a positive answer, wherein the negative response comprises a negative answer, and wherein the principle is selected from a set of principles comprising one or more of relevance, groundedness, truthfulness, and thoroughness.

Example 6: The method of Example 1, wherein the preference model is trained with the positive score and the negative score by evaluating a margin loss function that subtracts the negative score from the positive score.

Example 7: The method of Example 6, wherein the loss function comprises a constant value that determines a magnitude of a loss value generated by the loss function, further comprising:
quantifying how much more the positive response adheres to the principle than the negative response; and setting the constant value of the loss function proportional to how much more the positive response adheres to the principle than the negative response.

Example 8: A system comprising: a processing unit; and a computer-readable storage medium having computer-executable instructions stored thereupon, which, when executed by the processing unit, cause the processing unit to: select a principle associated with a scenario of a large language model; obtain a question; construct a positive answer to the question that adheres to the principle; construct a negative answer to the question that does not adhere to the principle; obtain a positive score from a preference model for the positive answer; obtain a negative score from the preference model for the negative answer; and train the preference model with the positive score and the negative score.

Example 9: The system of Example 8, wherein the principle comprises usefulness, wherein the positive answer is constructed by retrieving an upvoted answer to the question from a community question and answer forum, and wherein the negative answer is constructed by retrieving an answer to the question from the community question and answer forum that has fewer upvotes than the upvoted answer.

Example 10: The system of Example 8, wherein the principle comprises relevance, wherein the positive answer is constructed by retrieving an upvoted answer to the question from a community question and answer forum, and wherein the negative answer is constructed by retrieving an answer to a related question.

Example 11: The system of Example 8, wherein the principle comprises groundedness, wherein the positive answer is constructed by prompting an individual machine learning model to answer the question, and wherein the negative answer is constructed by prompting an individual machine learning model to answer the question with citations.

Example 12: The system of Example 8, wherein the principle comprises truthfulness, wherein the positive answer is constructed by prompting an individual machine learning model to answer the question, and wherein the negative answer is constructed by prompting an individual machine learning model to answer the question believably but with inaccuracies.

Example 13: The system of Example 8, wherein the principle comprises thoroughness, wherein the positive answer is constructed by prompting an individual machine learning model to combine different answers to the question, and wherein the negative answer is constructed by prompting an individual machine learning model to answer the question.

Example 14: The system of Example 8, wherein the principle comprises relevant vs irrelevant grounding, wherein the positive answer is constructed by prompting an individual machine learning model to answer the question and to include citations determined by a retrieval system to be high quality, and wherein the negative answer is constructed by prompting an individual machine learning model to answer the question and to include citations determined by the retrieval system to be low quality.

Example 15: A computer-readable storage medium having encoded thereon computer-readable instructions that when executed by a processing unit cause a system to: select a principle associated with a scenario of a large language model; obtain a question; construct a positive answer to the question that adheres to the principle; construct a negative answer to the question that does not adhere to the principle; obtain a positive score from a preference model for the positive answer; obtain a negative score from the preference model for the negative answer; and train the preference model by evaluating a loss function that computes a loss with the positive score and the negative score.

Example 16: The computer-readable storage medium of Example 15, wherein the preference model is used as part of a reinforcement learning with human feedback technique to train the large language model.

Example 17: The computer-readable storage medium of Example 15, wherein the scenario comprises generating a movie script.

Example 18: The computer-readable storage medium of Example 15, wherein the positive score is obtained from the preference model by providing the preference model with a combination of the question and the positive answer.

Example 19: The computer-readable storage medium of Example 15, wherein the positive answer and the negative answer have similar content.

Example 20: The computer-readable storage medium of Example 15, wherein the loss function generates a loss when the positive score exceeds the negative score by less than a defined margin.

### CONCLUSION

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Furthermore, references have been made to publications, patents and/or patent applications throughout this specification. Each of the cited references is individually incorporated herein by reference for its particular cited teachings as well as for all that it discloses.

What is claimed is:

1. A method comprising:
selecting a principle associated with a scenario of a large language model;
obtaining a prompt;
constructing a positive response to the prompt that adheres to the principle;
constructing a negative response to the prompt that does not adhere to the principle;
obtaining a positive score from a preference model for the positive response;
obtaining a negative score from the preference model for the negative response; and
training the preference model with the positive score and the negative score.

2. The method of claim 1, wherein the principle is selected from a plurality of principles associated with the scenario.

3. The method of claim 1, wherein the positive response and the negative response are constructed to highlight adherence to the principle.

4. The method of claim 3, wherein the positive response and the negative response highlight adherence to the principle by being constructed to be substantially similar in aspects other than the principle.

5. The method of claim 1, wherein the scenario comprises long-form question and answer, wherein the prompt comprises a question, wherein the positive response comprises a positive answer, wherein the negative response comprises a negative answer, and wherein the principle is selected from a set of principles comprising one or more of relevance, groundedness, truthfulness, and thoroughness.

6. The method of claim 1, wherein the preference model is trained with the positive score and the negative score by evaluating a margin loss function that subtracts the negative score from the positive score.

7. The method of claim 6, wherein the loss function comprises a constant value that determines a magnitude of a loss value generated by the loss function, further comprising:
quantifying how much more the positive response adheres to the principle than the negative response; and
setting the constant value of the loss function proportional to how much more the positive response adheres to the principle than the negative response.

8. A system comprising:
a processing unit; and
a computer-readable storage medium having computer-executable instructions stored thereupon, which, when executed by the processing unit, cause the processing unit to:
select a principle associated with a scenario of a large language model;
obtain a question;
construct a positive answer to the question that adheres to the principle;
construct a negative answer to the question that does not adhere to the principle;
obtain a positive score from a preference model for the positive answer;
obtain a negative score from the preference model for the negative answer; and
train the preference model with the positive score and the negative score.

9. The system of claim 8, wherein the principle comprises usefulness, wherein the positive answer is constructed by retrieving an upvoted answer to the question from a community question and answer forum, and wherein the negative answer is constructed by retrieving an answer to the question from the community question and answer forum that has fewer upvotes than the upvoted answer.

10. The system of claim 8, wherein the principle comprises relevance, wherein the positive answer is constructed by retrieving an upvoted answer to the question from a community question and answer forum, and wherein the negative answer is constructed by retrieving an answer to a related question.

11. The system of claim 8, wherein the principle comprises groundedness, wherein the positive answer is constructed by prompting an individual machine learning model to answer the question, and wherein the negative answer is constructed by prompting an individual machine learning model to answer the question with citations.

12. The system of claim 8, wherein the principle comprises truthfulness, wherein the positive answer is constructed by prompting an individual machine learning model to answer the question, and wherein the negative answer is constructed by prompting an individual machine learning model to answer the question believably but with inaccuracies.

13. The system of claim 8, wherein the principle comprises thoroughness, wherein the positive answer is constructed by prompting an individual machine learning model to combine different answers to the question, and wherein the negative answer is constructed by prompting an individual machine learning model to answer the question.

14. The system of claim 8, wherein the principle comprises relevant vs irrelevant grounding, wherein the positive answer is constructed by prompting an individual machine learning model to answer the question and to include citations determined by a retrieval system to be high quality, and wherein the negative answer is constructed by prompting an individual machine learning model to answer the question and to include citations determined by the retrieval system to be low quality.

15. A computer-readable storage medium having encoded thereon computer-readable instructions that when executed by a processing unit cause a system to:
select a principle associated with a scenario of a large language model;
obtain a question;
construct a positive answer to the question that adheres to the principle;
construct a negative answer to the question that does not adhere to the principle;
obtain a positive score from a preference model for the positive answer;
obtain a negative score from the preference model for the negative answer; and
train the preference model by evaluating a loss function that computes a loss with the positive score and the negative score.

16. The computer-readable storage medium of claim 15, wherein the preference model is used as part of a reinforcement learning with human feedback technique to train the large language model.

17. The computer-readable storage medium of claim 15, wherein the scenario comprises generating a movie script.

18. The computer-readable storage medium of claim 15, wherein the positive score is obtained from the preference model by providing the preference model with a combination of the question and the positive answer.

19. The computer-readable storage medium of claim 15, wherein the positive answer and the negative answer have similar content.

20. The computer-readable storage medium of claim 15, wherein the loss function generates a loss when the positive score exceeds the negative score by less than a defined margin.
